(19) United States
(12) Patent Application Publication
(10) Pub. No.: US 2010/0194865 A1
(43) Pub. Date: Aug. 5, 2010

(54) METHOD OF GENERATING AND DISPLAYING A 3D IMAGE AND APPARATUS FOR PERFORMING THE METHOD

(75) Inventor: Al Kusada, Mahwah, NJ (US)

Correspondence Address: GIFFORD, KRASS, SPRINKLE,ANDERSON & CITKOWSKI, P.C, PO BOX 7021, TROY, MI, 48007-7021, US

(73) Assignee: Tunable Optix Corporation, Hsinchu (TW)

(21) Appl. No.: 12/700,093

(22) Filed: Feb. 4, 2010

Related U.S. Application Data
(60) Provisional application No. 61/149,816, filed on Feb. 4, 2009.
(60) Provisional application No. 61/149,830, filed on Feb. 4, 2009.

(51) Int. Cl. H04N 13/04

(52) U.S. Cl. 348/52; 348/E13.075

(57) ABSTRACT

To provide an image of a scene having three-dimensional characteristics, without the use of special glasses, a special camera employing an electrically controllable LCD lens which may be changed as to focal length by varying an applied voltage is used to record a plurality of images of the scene at each of a plurality of closely spaced focal lengths. All of the recorded images are simultaneously displayed on a device employing a stack of transparent LCD screens with one image being provided to each screen in the same order as the focal lengths used during the recording step.

### CROSS-REFERENCE TO RELATED APPLICATIONS

This application claims priority of U.S. Provisional Patent Applications 61/149,816 and 61/149,830 filed Feb. 4, 2009, which are incorporated herein by reference.

### FIELD OF THE INVENTION

This invention relates to methods and apparatus for recording and displaying images of a scene which presents a three-dimensional visual effect without the use of special glasses or the like, involving the recording of a plurality of images of the scene at a series of closely spaced focal lengths and then the display of the recorded images on a stack of transparent LCD screens.

### BACKGROUND OF THE INVENTION

A variety of systems exist for recording an image of a scene and then displaying the image in such a way as to give the viewer the impression of visualizing the scene in three dimensions. The majority of such 3D display systems depend upon the stereoscopic effect involving the substantially simultaneous delivery to the viewer of two images of the scene taken by two spaced cameras and then displaying each of the images to a different eye of the viewer, usually using colored glasses.

It would obviously be desirable to avoid the need for special glasses or the like, and a class of 3D imaging systems have been developed which allow the viewer to view a scene without the need to wear special glasses. One such system utilizes a display device comprising a stack of transparent screens, preferably of the LCD variety, which screens are each provided with an image of the object taken from the same point of view but at differing focal lengths. One such display device is disclosed in U.S. Pat. No. 5,113,272.

This system presents a number of limitations, largely in terms of the difficulty of producing the required images in a short time period so that the process may be used with scenes undergoing motion as well as static screens.

### SUMMARY OF THE INVENTION

The present invention is directed toward a method and apparatus for recording and displaying images of a scene so that they may be viewed with a three-dimensional effect which utilizes a camera employing a voltage controlled LCD lens driven by a computer based voltage control system which allows the formation of a series of images of a scene, each at a different focal length, very rapidly. These images are preferably digitally recorded. During display each of the images is provided to one of an LCD screen in a stack, in the order of the focal lengths employed by the camera during recording.

The images may be recorded at all of the required focal lengths with sufficient rapidity that motion of the image or elements in the image during the recording process can be tolerated, as long as the rate of motion is low relative to the rate at which the series of images is recorded. This can provide true video images in a three-dimensional manner without the need for special glasses or the like.

### BRIEF DESCRIPTION OF THE DRAWINGS

Other objectives, advantages, and applications of the present invention will be made apparent by the following detailed description of a preferred embodiment of the invention. The description makes reference to the accompanying drawings in which:

FIG. 1 is a partially perspective, partially schematic illustration of an imaging and display system constituting the preferred embodiment of the present invention; and

FIG. 2 is a schematic diagram of the preferred embodiment of the system.

### DETAILED DESCRIPTION OF A PREFERRED EMBODIMENT

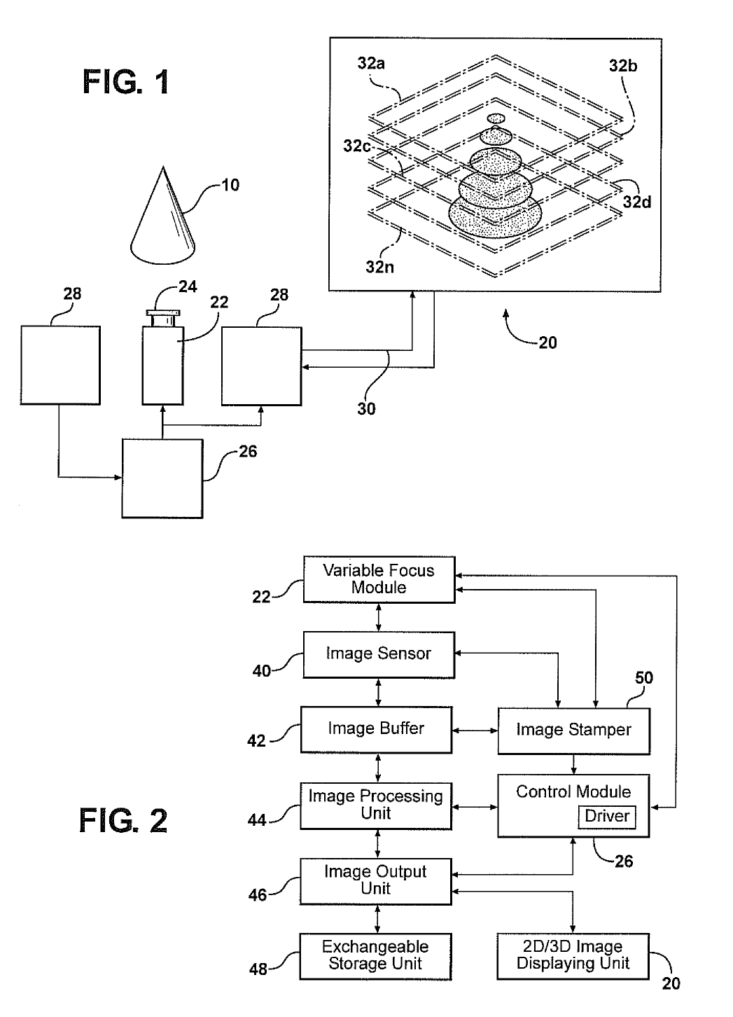

The system of the present invention is adapted to capture an image of a scene, which is typified in FIG. 1 by a cone 10, and to generate an electronic display of the scene using a display device generally indicated at 20 in either two-dimensional form or, preferably, three-dimensional form.

The system generally comprises a camera 22 having a lens 24 which captures light reflected from the scene 10. The lens 24 of the camera 22 may be of the type which uses an incremental stepping motor to cycle a zoom lens through a plurality of different focal lengths, but preferably takes the form of an electrically tunable liquid crystal lens. This lens may be of the type well known in the art, such as is disclosed in U.S. patent application Ser. No. 11/850,248. Broadly it consists of a liquid crystal element sandwiched between two electrodes which are so shaped that when the voltage between the electrodes is varied the refractive index of the lens, and thus its focal length, are varied. This shift in focal lengths may take place extremely rapidly so that a series of photographs of differing focal lengths, particularly closely spaced focal lengths, may be performed very rapidly.

In the system of FIG. 1 the focal lengths are controlled by controller 26 which provides signals to the camera 22. The controller 26 receives an input from a 2D/3D switch 28. This allows the camera 22 to be used in a conventional manner to capture a single image of an object 10 at a particular focal length for display on a single liquid crystal plane. Alternatively, the switch may be actuated by the user to a 3D variety, in which case the focal controller 26 sends a sequence of signals to the camera 22 which results in the application of different voltages to the liquid crystal lens 24 so as to form a series of images of the object 10 at spaced focal lengths.

These multiple images are stored in a memory buffer 28 under control of the controller 26. The memory buffer 28 is connected by a cable 30 to the 3D display unit 20 and is adapted to supply the plurality of images to different 2D liquid crystal display units 32a-32n. These units are preferably LCD screens. The number of two-dimensional display units in the stack 32a-32n of the camera 20 may be varied, and a higher number of image planes produces a higher resolution image. As is schematically illustrated in FIG. 1, the stack of the display unit 20 produces a series of images on the display planes 32a-32n which create a three-dimensional image of the object 10.

Each LCD display plane 32a-32n contains a matrix of switchable pixels. In a first state of switching the pixels may be nontransparent by strongly absorbing and/or scattering incident light, or interact with incident light so as to cause it to be absorbed by associated elements such as polarizers (not shown) while in the second visual state the pixels may be substantially transparent, permitting incident light to be reflected back to the viewer by a reflector located behind them (not shown) or permitting, in the case of a backlit display, that light pass through the display and reach the viewer. Since the pixels in the second state are transparent, it is possible to view underlying layers of the liquid crystal stack from the top side, as illustrated in FIG. 1, producing a real 3D image that may be inspected from all sides and moved as the viewer's head moves.

FIG. 2 is a schematic diagram of the system of FIG. 1 in more detail.

The camera 22, denominated as the “variable focus module” in FIG. 2, receives a desired focal length, developed in a manner which will be subsequently described in detail, from the controller 26. An image sensor 40, forming part of the camera 22, collects the input image and provides it to an image buffer 42. The output from the image buffer is provided to an image processing unit 44 which assembles the inputs from the sensor into a unitary image. The image is provided to an image output unit 46 which may provide it to a display unit 20 or an exchangeable storage unit 48 constituting a removable memory.

At an initial state of the unit the control module 26 issues a reset command to all of the modules in the system, bringing them to a default state. The camera module 26 then provides a voltage to its liquid crystal lens which focuses it on either the shortest or the longest focal position of the module and to the default lens module such as macro, zoom, or some particular F-number lens of the variable focus module 22. The image stamper 50 then resets at least an internal registering unit (not shown). The image sensor 40 is similarly reset so it will be ready to accept a command from the control module 26 to set up the optical performance required for the particular image or scene to be captured. A driver unit within the control module 26, the image buffer 42, and the image processing unit not only delete all unrequired data that existed but they are all reset to a default condition.

The control module 26 then issues a command to its internal driver unit to output a suitable driving signal so that the variable focus module 22 can span a specific range of its focal lengths. The image of the scene is then captured by the image sensor 40 through the variable focus module 22 while the variable focus module scans the focal range at a series of preselected step distances. The image of the scene thus captured is then provided to the image buffer 42.

The particular range of focal lengths scanned can be set by the user depending upon the nature of the particular object or scene that the user would like to image. As the steps between the various focal lengths are decreased, more detail is captured by the image sensor and a higher resolution image may be created.

The 2D/3D image displaying unit may be controlled so as to receive only a single image, which is typically displayed on the liquid crystal plane 32a, or a 3D image in which images of various focal lengths are provided to a number of the image planes or all of the image planes.

Having thus described my invention I claim.

1. The method of generating and displaying a 3D image of a scene without the need for special viewing glasses or the like, comprising:
recording in succession a plurality of 2D images of the scene at each of a plurality of differing focal lengths; and
displaying all of said images simultaneously on a stack of a plurality of LCD screens with one image provided to each screen in the stack in the same order as the focal lengths used during the recording step.

2. The method of claim 1, wherein the recording step employs a camera with an LCD voltage controlled lens, with the voltage, and thus the focal length of the lens, modified between each successive recording.

3. The method of claim 1, wherein the LCD screens are substantially transparent in areas in which no image is displayed so that lower images in the stack are visible through the transparent areas of higher screens.

4. The method of claim 2, wherein the voltage is applied across a pair of electrodes sandwiching the lens.

5. The method of claim 1, wherein the voltage applied to the LCD lens is controlled by a computer-based system.

6. The method of claim 1 in which the step of recoding a plurality of 2D images of the scene at a plurality of differing focal lengths employs a camera with a mechanically adjustable zoom lens actuated by a stepping motor.
